(19) United States
(12) Patent Application Publication
(10) Pub. No.: US 2015/0245069 A1
(43) Pub. Date: Aug. 27, 2015

(54) IMAGE DECODING APPARATUS, IMAGE DECODING METHOD, AND PROGRAM

(71) Applicant: CANON KABUSHIKI KAISHA, Tokyo (JP)

(72) Inventor: Satoshi Naito, Yokohama-shi (JP)

(21) Appl. No.: 14/625,490

(22) Filed: Feb. 18, 2015

(30) Foreign Application Priority Data
Feb. 21, 2014 (JP) 2014-032212

(51) Int. Cl. H04N 19/61; H04N 19/503; H04N 19/176

(52) U.S. Cl. CPC H04N 19/61; H04N 19/176; H04N 19/503

(57) ABSTRACT

An image decoding apparatus updates the value of a register holding the value of a coded block flag (CBF) at high speed. The image decoding apparatus initializes all the values of registers holding the values of CBFs to a predetermined initial value, before starting processing on each coding tree unit (CTU) in a picture. Only in a case where the value of a decoded CBF is different from the initial value, the image decoding apparatus updates the value of a register to the value of the decoded CBF.

### BACKGROUND OF THE INVENTION

1. Field of the Invention

The present invention relates to an image decoding apparatus, an image decoding method, and a program, in particular to entropy decoding processing.

2. Description of the Related Art

H.264/MPEG-4AVC, which stands for Motion Picture Experts Group 4 Advanced Video Coding (hereinafter referred to as “H.264”), has been known as a coding system used for compression recording of a moving image. In recent years, efforts to establish international standardization of a higher-efficiency coding system succeeding to H.264 have started. In this connection, Joint Collaborative Team on Video Coding (JCT-VC) has been established between International Organization for Standardization/International Electrotechnical Commission (ISO/IEC) and International Telecommunication Unit Telecommunication Standardization Sector (ITU-T). JCT-VC has established a coding system called High Efficiency Video Coding (hereinafter referred to as “HEVC”) as a standard.

HEVC encodes a picture, by using a block called “coding tree unit” (hereinafter referred to as “CTU”) as a unit. A CTU is constituted by the blocks each referred to as “coding unit” (hereinafter referred to as “CU”) that are hierarchically defined in a tree structure. A CU includes an element called “prediction unit” and an element called “transform tree”. The prediction unit includes a mode used for intra-frame prediction or inter-frame prediction and a motion vector. The transform tree will be described below.

In HEVC, a rectangle acting as a unit of orthogonal transformation is named “transform unit” (hereinafter referred to as “TU”). Each TU forms an element called “transform tree” that hierarchically includes TUs as illustrated in FIG. 9A. A syntax element named “split transform flag” is defined at each level of the transform tree. The syntax element indicates whether to divide a TU further. In HEVC, the size of the rectangular of the orthogonal transformation can be flexibly selected by providing such a hierarchical structure, as illustrated in FIG. 9B, for example.

In HEVC, information indicating whether an orthogonally transformed TU includes a transformation coefficient of a non-zero value is encoded with a syntax element named “coded block flag” (hereinafter referred to as “CBF”). In HEVC, cbf_luma, cbf_cb, and cbf_cr are defined as CBFs for a Y component (a luminance component), a Cb component (a color-difference component), a Cr component (a color-difference component), respectively. The components form a pixel.

Of the CFBs, cbf_cb and cbf_cr (hereinafter referred to as “color-difference CBF”) are encoded at each level of the transform tree. When the value of the color-difference CBF at a certain level is “0”, the value of a transformation coefficient of a color difference (either “cb” or “cr”) is “0” in each of all TUs included in this certain level or a lower level. On the other hand, when the value of the color-difference CBF at a certain level is at least one transformation coefficient of a color difference, whose value is not “0”, is present in any of TUs included in a transform tree at this certain level or lower.

As described above, the color-difference CBF is encoded at each level of the transform tree. Specifically, the color-difference CBF is expressed in a syntax structure illustrated in FIG. 8. As expressed by a discriminant (1) in FIG. 8, when a value (cbf_cb[xBase][yBase][trafoDepth−1] in FIG. 8) of cbf_cb at a certain level is “0”, a value “0” is implicitly derived at a level immediately below this level as cbf_cb does not appear in encoded data. As for cbf_cr as well, an implicit value is derived in a manner similar to cbf_cb, as expressed by a discriminant (2) in FIG. 8. FIGS. 10A and 10B each illustrate an example of the way of implicitly deriving the value of the color-difference CBF. In FIG. 10A, the value of a color-difference CBF in a region 1001 at a level #1 is “0”. Therefore, “0” is implicitly derived as the value of each of four color-differences CBF located at a level #2 below the level #1. The value in each of regions 1002 and 1003 at the level #2 is similarly “0”. At a level #3 below the level #2, the values of color-differences CBF corresponding to each of the regions 1002 and 1003 are implicitly “0” (indicated as shaded areas in FIG. 10A). Further, as illustrated in FIG. 10B, when the value of a CBF at an uppermost level is “0”, the values of all color-differences CBF at levels below the uppermost level are implicitly “0”.

On the other hand, as for cbf_luma (hereinafter referred to as “luminance CBF”), unlike the color-difference CBF, encoding is performed not at each level of the transform tree, but for each TU. Further, as expressed by a discriminant (3) in FIG. 8, the luminance CBF appears in encoded data, when a CU to be encoded indicates intra prediction, a hierarchy depth of the transform tree to be encoded is not “0”, or encode target cbf_cb or cbf_cr is “1”. When none of these conditions are satisfied (no luminance CBF appears in encoded data), “1” is implicitly derived as the value of the luminance CBF at a level concerned.

Meanwhile, the value of a CBF is referred to in expanding a transformation coefficient to be subjected to inverse quantization/inverse orthogonal transformation processing. Therefore, it is necessary to hold the value of the CBF in a register or the like at the time of decoding. In an image decoding apparatus that supports HEVC, a register is implemented to hold the value of a CBF at each level as illustrated in FIG. 4, to deal with every splitting pattern of a CU or a TU. In this case, at the time of implicitly deriving the value of the CBF, processing for updating the value of a register becomes complicated, which is a problem.

For example, as illustrated in FIG. 11, assume that a decoded value of a color-difference CBF in a region 1101 at a level #1 is “0”. In this case, values in all of four registers corresponding to a region 1102 at a level #2 and sixteen registers corresponding to a region 1103 at a level #3, need to be updated to “0”. If this updating is performed in a large-scale integrated (LSI) circuit, a processing time for twenty clock cycles is necessary for updating twenty registers in total, which reduces a decoding processing speed.

### SUMMARY OF THE INVENTION

The present invention is directed to decoding processing at a higher speed, by reducing complexity of processing for updating a register value in implicitly deriving the value of a CBF.

According to an aspect of the present invention, an image decoding apparatus decodes encoded data representing an encoded picture that is split using a coding tree unit including coding units hierarchically defined in a tree structure, as a unit, wherein the coding unit includes a transform tree including transform units hierarchically defined in a tree structure, the encoded data includes as a syntax element a coded block flag indicating whether each of the transform units includes a non-zero value. The image decoding apparatus includes, a syntax-element decoding unit configured to decode a syntax element, a coded-block-flag holding unit configured to hold a value of the coded block flag corresponding to each of the transform units, and, a flag-value updating unit configured to update the value held by the coded-block-flag holding unit. The flag-value updating unit initializes the value held by the coded-block-flag holding unit to a predetermined initial value before processing is performed on each of the coding tree units, and updates, in a case where a value of the coded block flag decoded by the syntax-element decoding unit is different from the predetermined initial value, the corresponding value held by the coded-block-flag holding unit, to the value of the decoded coded block flag.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image decoding apparatus according to an exemplary embodiment.

FIG. 2 is a block diagram illustrating a detailed configuration of an encoded-data decoding unit according to the present exemplary embodiment.

FIG. 3 is a flowchart illustrating processing of a flag-value updating unit according to the present exemplary embodiment.

FIG. 4 is a conceptual diagram of a register held by a coded-block-flag holding unit.

FIGS. 5A and 5B are diagrams each illustrating an initial value of a register holding the value of a coded block flag (CBF).

FIG. 6 is a diagram illustrating how the value of a color-difference CBF register is updated.

FIG. 7 is a diagram illustrating how the value of a luminance CBF register is updated.

FIG. 8 is a diagram illustrating syntax of a transform tree.

FIGS. 9A and 9B are diagrams illustrating a concept of a transform tree and a split of a transform unit by an example.

FIGS. 10A and 10B are diagrams each illustrating implicit derivation of the value of a CBF by an example.

FIG. 11 is a diagram illustrating how the value of a CBF register is updated in a conventional image decoding apparatus.

FIG. 12 is a block diagram illustrating a hardware configuration example of a computer applicable to an image decoding apparatus according to an exemplary embodiment of the present invention.

### DESCRIPTION OF THE EMBODIMENTS

Any configuration in an exemplary embodiment to be described below is only an example, and the present invention is not limited to any configuration illustrated in the drawings.

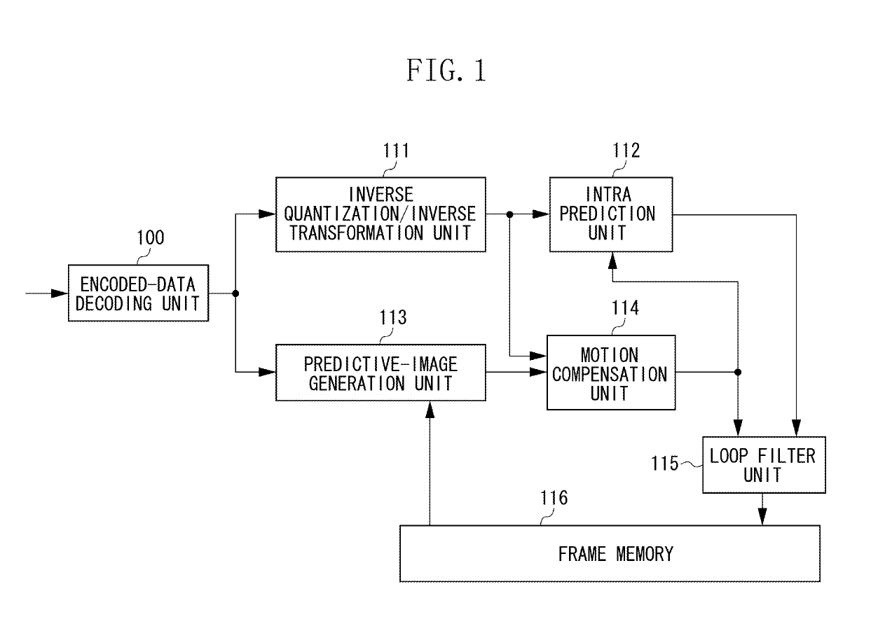

FIG. 1 illustrates a configuration of an image decoding apparatus according to the present exemplary embodiment. The image decoding apparatus of the present exemplary embodiment will be described below with reference to FIG. 1.

The image decoding apparatus of the present exemplary embodiment decodes encoded data that is encoded by High Efficiency Video Coding (HEVC), although the present invention is not limited thereto. In the following description, a coding tree unit serving as a component of the encoded data of HEVC will be referred to as “CTU”. Similarly, a coding unit will be referred to as “CU”, a transform unit as “TU”, and a coded block flag as “CBF”. A CBF of a luminance component will be referred to as “cbf_luma” or “luminance CBF”. A CBF of a color-difference component Cb will be referred to as “cbf_cb”, and a CBF of a color-difference component Cr as “cbf_cr”. Further, “cbf_cb” and “cbf_cr” may also be collectively referred to as “color-difference CBF”. The image decoding apparatus of the present exemplary embodiment decodes encoded data obtained by encoding a picture. The picture is split as a unit using a coding tree unit constituted by coding units hierarchically defined in a tree structure. Further, the coding unit includes a transform tree constituted by transform units hierarchically defined in a tree structure. The encoded data includes as a syntax element a coded block flag that indicates whether each of the transform units includes a non-zero value.

An encoded-data decoding unit 100 entropy-decodes externally input encoded data, for each CTU constituting a picture. The encoded-data decoding unit 100 then outputs a transformation coefficient, and encoding parameters such as motion vector data and a prediction mode. An inverse quantization/inverse transformation unit 111 performs inverse quantization and inverse transformation on the transformation coefficient output from the encoded-data decoding unit 100 to output prediction residual data as a result. An intra prediction unit 112 generates an intra prediction value from decoded peripheral pixel data. The intra prediction unit 112 adds the generated intra prediction value to the prediction residual data output from the inverse quantization/inverse transformation unit 111, and then outputs decoded image data as a result.

A predictive-image generation unit 113 reads a reference pixel from a frame memory 116, based on the motion vector data output from the encoded-data decoding unit 100. The predictive-image generation unit 113 generates a predictive image based on the read reference pixel, and outputs the generated predictive image to a motion compensation unit 114. The motion compensation unit 114 generates decoded image data, by adding the prediction residual data output from the inverse quantization/inverse transformation unit 111 to the predictive image output from the predictive-image generation unit 113. The motion compensation unit 114 then outputs the generated decoded image data to the intra prediction unit 112 and a loop filter unit 115.

The loop filter unit 115 performs various filtering processes such as block deformation removal, on the decoded image data output from the intra prediction unit 112 and the motion compensation unit 114. The decoded image data after the filtering processes is stored in the frame memory 116.

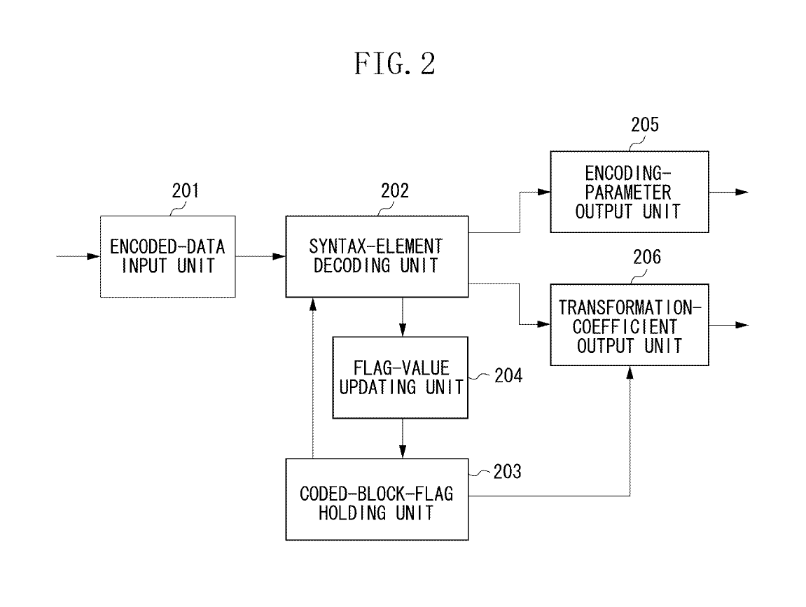

Next, a detailed configuration of the encoded-data decoding unit 100 will be described with reference to FIG. 2. An encoded-data input unit 201 holds the input encoded data in a first-in first-out (FIFO) memory (not illustrated) and a bit shifter (not illustrated). The encoded-data input unit 201 starts search for a top position of the encoded data by using a bit shifter, when requested by a syntax-element decoding unit 202 to perform search for the top position of the encoded data.

The syntax-element decoding unit 202 decodes the encoded data of various syntax elements that are entropy-encoded by context-adaptive arithmetic coding processing. Based on a result of the decoding, the syntax-element decoding unit 202 requests the encoded-data input unit 201 to perform search for the top position of the encoded data.

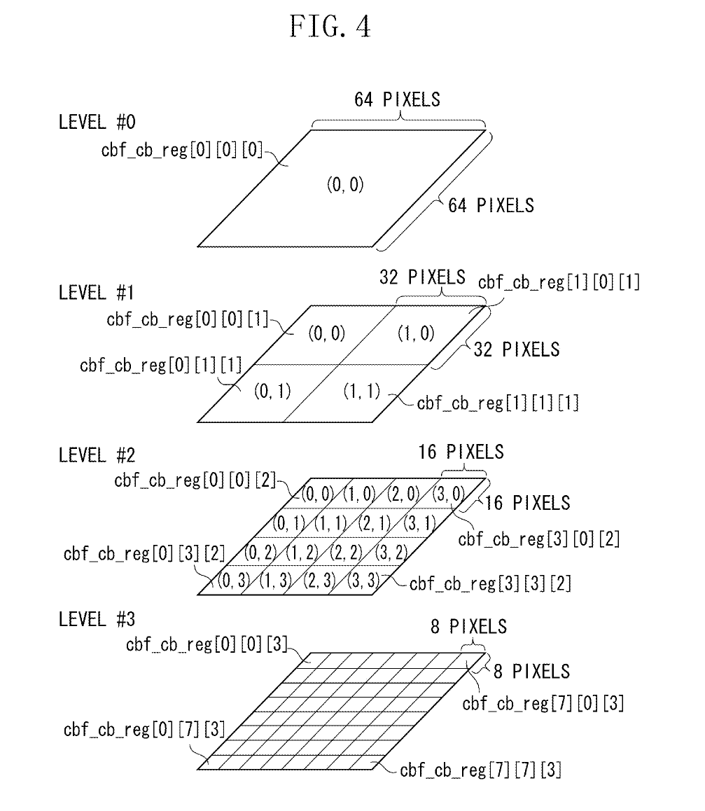

A coded-block-flag holding unit 203 includes a register that holds the value of a color-difference CBF corresponding to each level of a transform tree, as illustrated in FIG. 4. In FIG. 4, a level #0 corresponds to a size of 64×64 pixels. Similarly, a level #1 corresponds to a size of 32×32 pixels, a level #2 corresponds to a size of 16×16 pixels, and a level #3 corresponds to a size of 8×8 pixels. Only one register is provided at the level #0, four registers at the level #1, sixteen registers at the level #2, and sixty-four registers at the level #3. FIG. 4 illustrates the registers corresponding to cbf_cb as an example. The coded-block-flag holding unit 203 also includes registers corresponding to cbf_cr and cbf_luma.

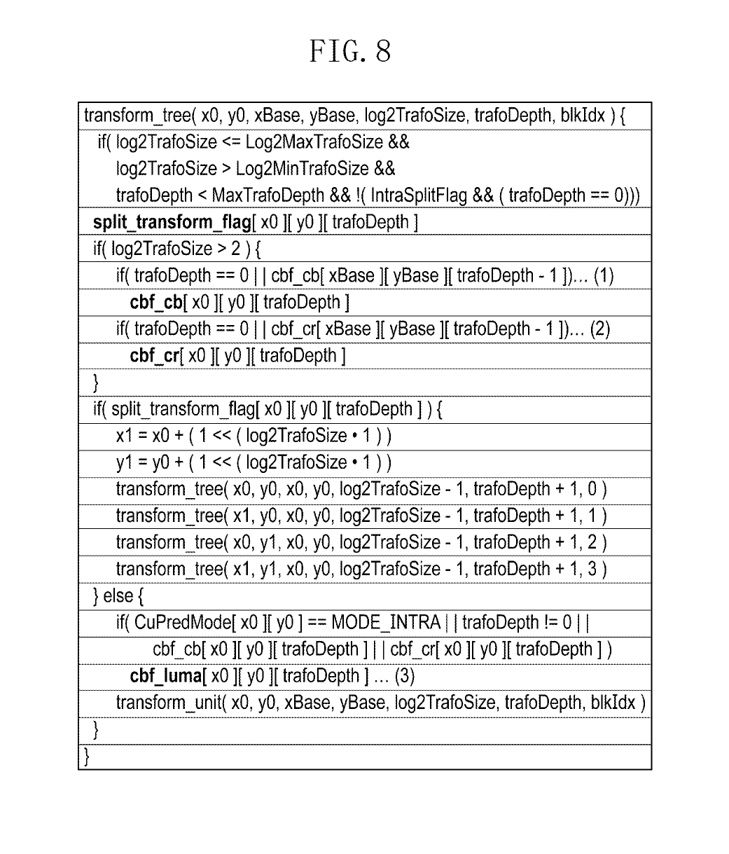

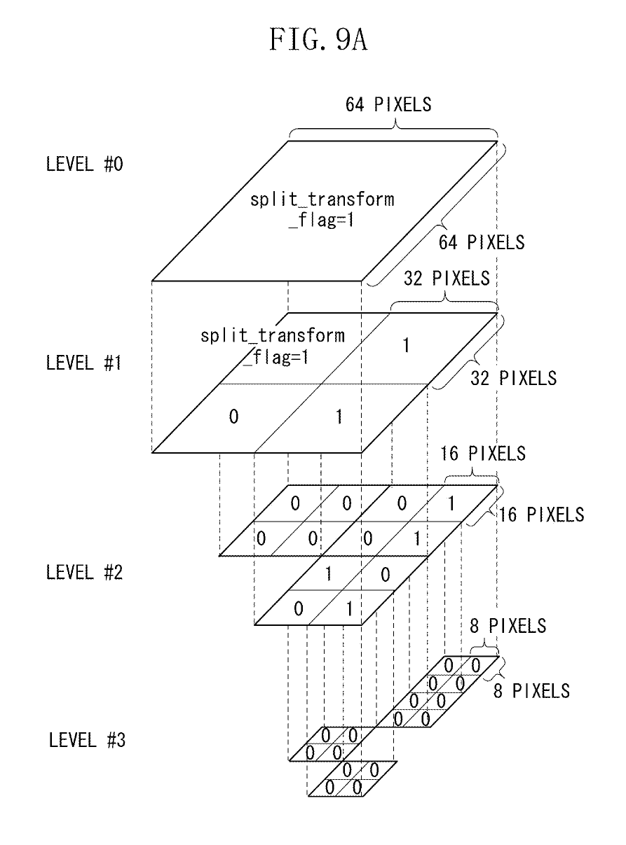

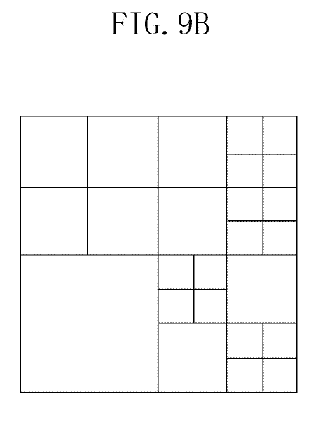

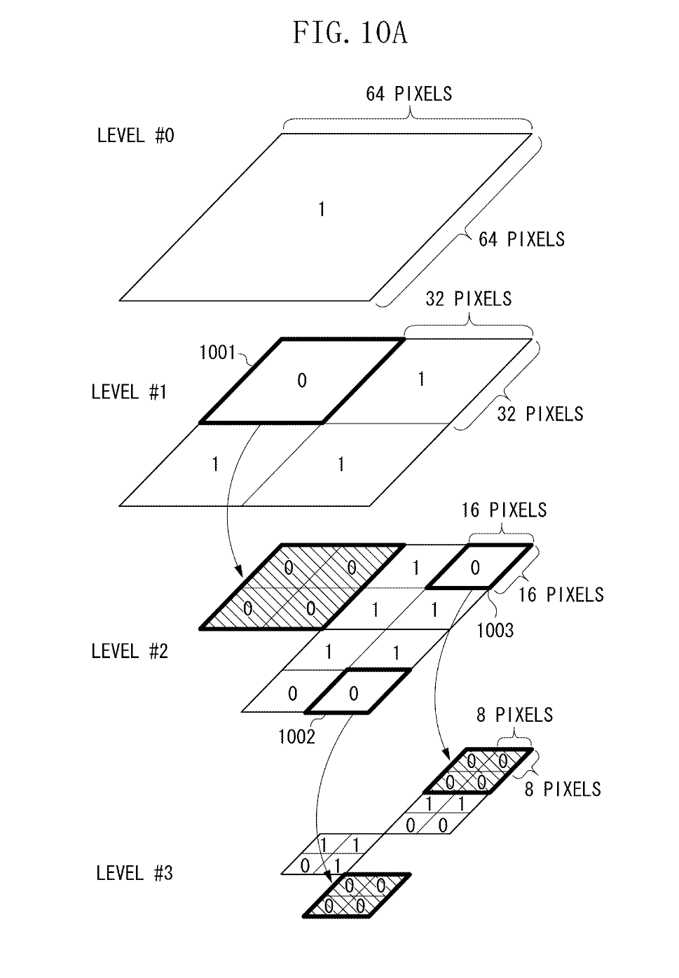

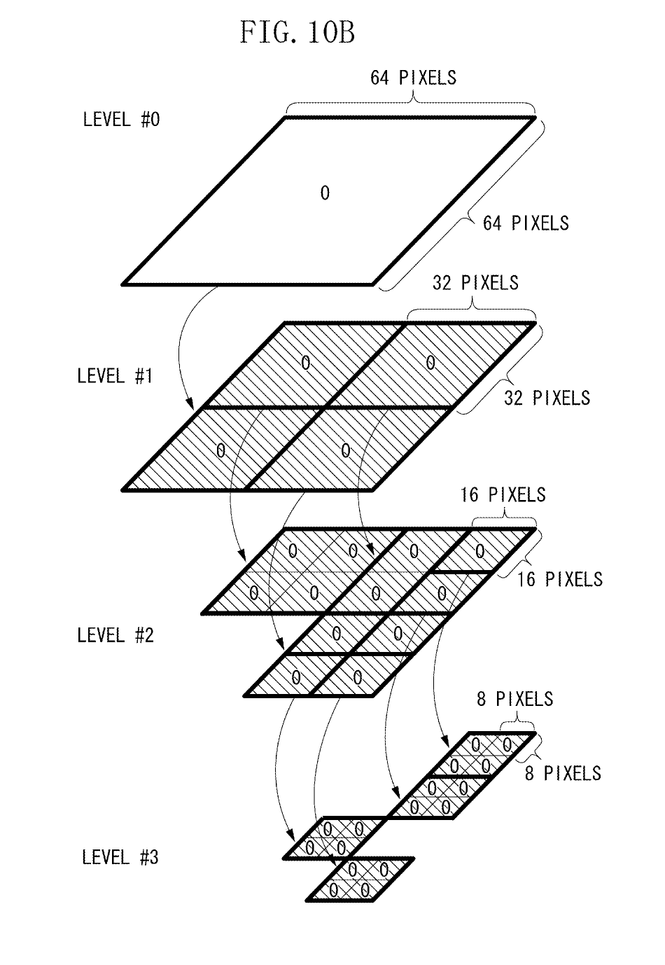

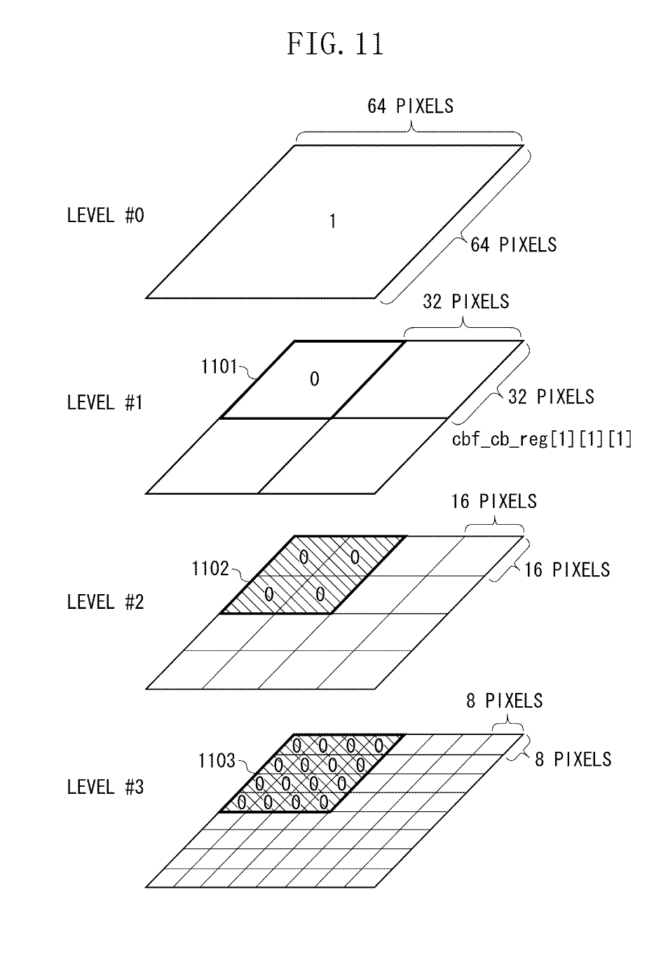

When the decoded syntax element is a CBF, the syntax-element decoding unit 202 outputs CBF information to a flag-value updating unit 204. Here, the CBF information includes the level number, the coordinates of a transform tree corresponding to the decoded CBF, the type (any one of cbf_luma, cbf_cb, and cbf_cr) of the decoded CBF, and the value of the decoded CBF. Further, as expressed by discriminants (1) and (2) in FIG. 8, the syntax-element decoding unit 202 needs to refer to a color-difference CBF at a level immediately above, to determine whether the color-difference CBF appears in the encoded data. Therefore, the syntax-element decoding unit 202 refers to the value of the color-difference CBF held in the coded-block-flag holding unit 203.

The flag-value updating unit 204 receives the CBF information output from the syntax-element decoding unit 202 and updates the value of the register included in the coded-block-flag holding unit 203. Detailed operation of the flag-value updating unit 204 will be described below.

An encoding-parameter output unit 205 outputs the encoding parameters such as the motion vector and the prediction mode decoded by the syntax-element decoding unit 202, to the inverse quantization/inverse transformation unit 111 (FIG. 1) and the predictive-image generation unit 113 (FIG. 1).

A transformation-coefficient output unit 206 outputs the transformation coefficient decoded by the syntax-element decoding unit 202, to the inverse quantization/inverse transformation unit 111 (FIG. 1). However, as for a TU where the value of a CBF is “0”, the value of a transformation coefficient corresponding thereto is not entropy-encoded. Therefore, this transformation coefficient is not output from the syntax-element decoding unit 202 to the transformation-coefficient output unit 206. In this case, the transformation-coefficient output unit 206 outputs the transformation coefficient, by referring to the value of the CBF held in the coded-block-flag holding unit 203. Specifically, when the value of the CBF is “0”, the transformation-coefficient output unit 206 interprets all the transformation coefficients of corresponding TUs as “0”, and outputs “0” to the inverse quantization/inverse transformation unit 111 (FIG. 1).

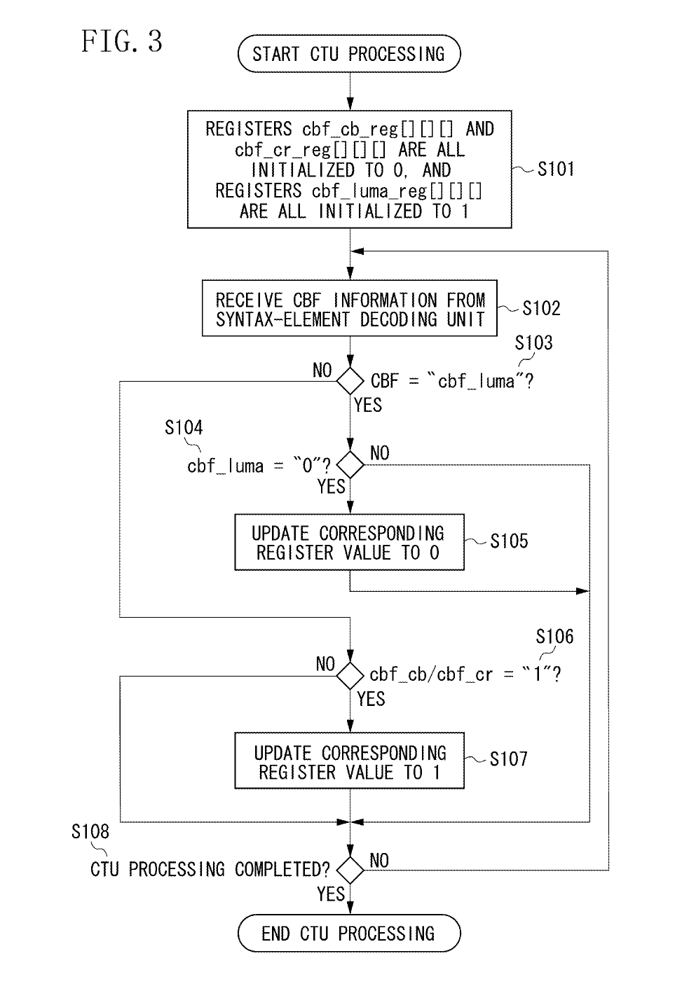

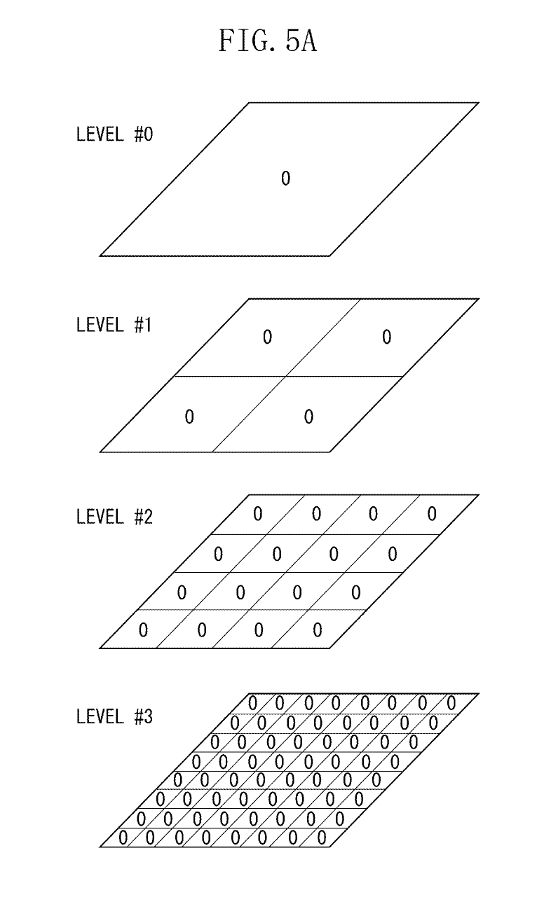

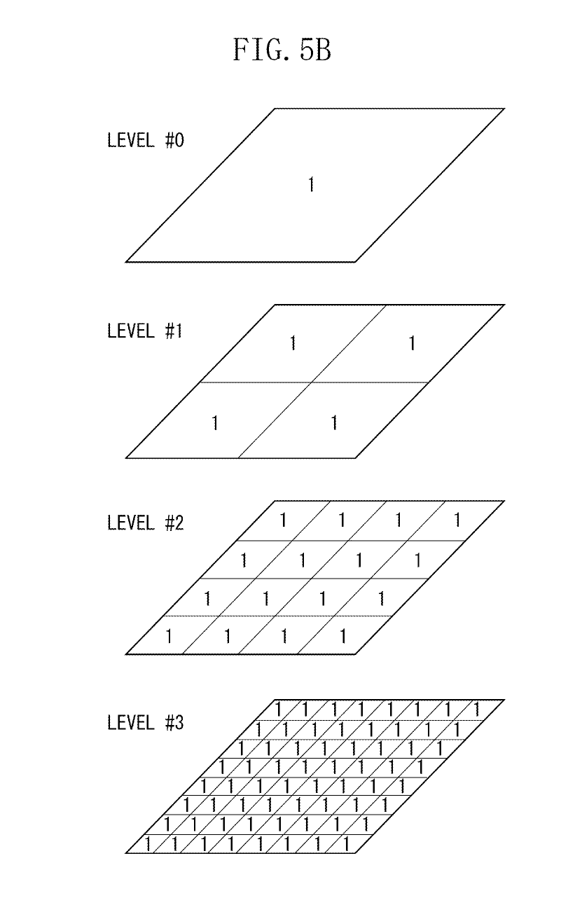

Next, the detailed operation of the flag-value updating unit 204 will be described with reference to a flowchart of FIG. 3. FIG. 3 illustrates a flow of processing performed on a CTU by the flag-value updating unit 204. First, in step S101, the flag-value updating unit 204 initializes a register holding the value of each CBF. FIG. 5A illustrates the register value of each color-difference CBF immediately after the initialization in step S101, and FIG. 5B illustrates the register value of each luminance CBF immediately after the initialization in step S101. Registers cbf_cb_reg[ ] [ ] [ ] and cbf_cr_reg[ ] [ ] [ ] corresponding to the color-difference CBFs are all initialized to “0”. On the other hand, registers cbf_luma reg[ ] [ ] [ ] corresponding to the luminance CBFs are all initialized to “1”.

Next, in step S102, the flag-value updating unit 204 receives CBF information from the syntax-element decoding unit 202. When the received CBF (in the received CBF information) is cbf_luma (Yes in step S103), the operation proceeds to step S104, otherwise (No in step S103, i.e., when the received CBF is cbf_cb or cbf_cr) the operation proceeds to step S106.

In step S104, the value of cbf_luma is determined. When the value of cbf_luma is “0” (Yes in step S104), the operation proceeds to step S105, otherwise (No in step S104) the operation proceeds to step S108. In step S105, the flag-value updating unit 204 identifies a register corresponding to the received CBF, based on the level number and the coordinates corresponding to the decoded CBF that are received from the syntax-element decoding unit 202, and updates the value of the identified register to “0”. Upon completion of the processing in step S105, the operation proceeds to step S108.

In step S106, the flag-value updating unit 204 determines the value of cbf_cb or cbf_cr in the CBF information received from the syntax-element decoding unit 202. When the value is “1” (Yes in step S106), the operation proceeds to step S107, otherwise (No in step S107) the operation proceeds to step S108.

In step S107, the flag-value updating unit 204 identifies a register corresponding to the received CBF, based on the type (either cbf_cb or cbf_cr) of the received CBF, the level number, and the coordinates corresponding to the CBF that are received from the syntax-element decoding unit 202, and updates the value of the identified register to “1”. Upon completion of the processing in step S107, the operation proceeds to step S108.

In step S108, the flag-value updating unit 204 determines whether the processing for the CTU is completed. In other words, the flag-value updating unit 204 determines whether the processing for all TUs included in the CTU is completed. The processing ends when the processing for the CTU is completed (Yes in step S108). Otherwise, the operation proceeds to step S102 (No in step S108).

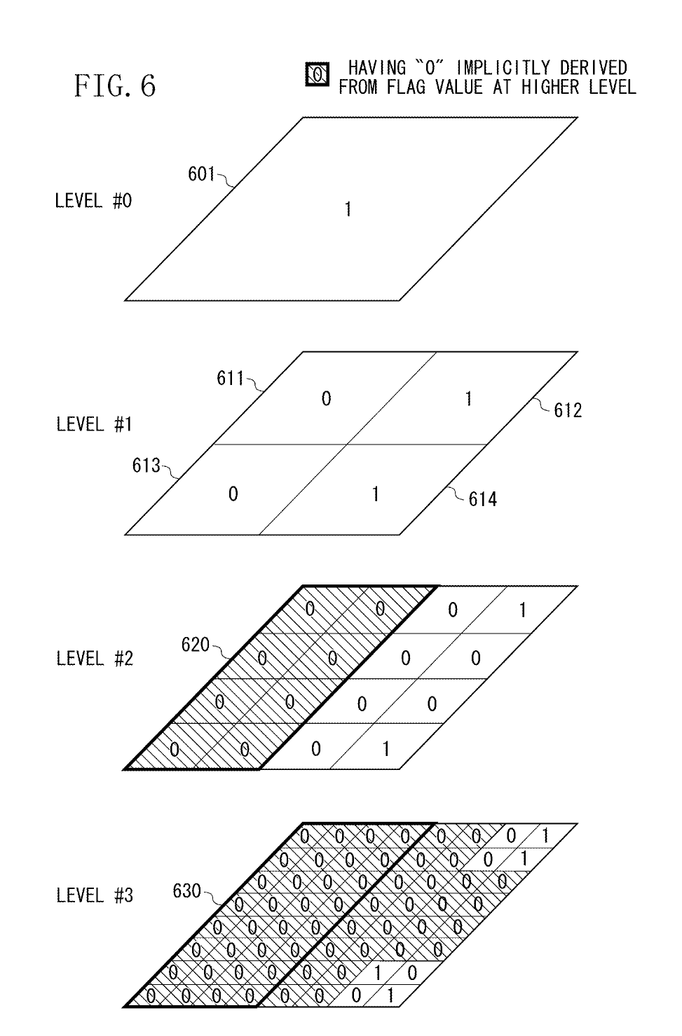

How the value of the register of the color-difference CBF is updated through the above-described processing will be described with reference to FIG. 6. For the sake of simplicity, it is assumed that a CU (a coding unit) has a size of 64×64 pixels, and all TUs forming a transform tree in the CU each have a size of 8×8 pixels.

In FIG. 6, as a result of decoding performed by the syntax-element decoding unit 202, a color-difference CBF at a level #0 is found to be “1”, and the value of a color-difference CBF register in a region 601 is updated to “1”. At a level #1, the value of a color-difference CBF in each of regions 612 and 613 is found to be “1”, and the value of a color-difference CBF register in each of the regions 612 and 613 is updated to “1”. On the other hand, the value of a color-difference CBF in each of regions 611 and 613 is found to be “0”, and the value of a corresponding color-difference CBF register is maintained at an initial value of “0”. At a level #2, color-difference CBFs in a region (in a solid frame 620), which corresponds to the regions 611 and 613 where the values of the color-difference CBFs are “0” at the level immediately above (the level #1), do not appear in encoded data, and “0” is implicitly derived. Likewise, “0” is implicitly derived for color-difference CBFs in a region 630 at a level #3. The values of registers corresponding to both of the regions 620 and 630 are not updated and each maintained at an initial value. In a conventional image decoding apparatus, for example, in decoding the color-difference CBF in the region 611 in FIG. 6, the color-difference CBF registers (the regions 620 and 630 in FIG. 6) at the lower levels need to be updated. Therefore, a large number of clock cycles are necessary to perform updating processing. In contrast, in the image decoding apparatus of the present exemplary embodiment, the values of the registers holding the values of the color-difference CBFs are all initialized to “0” in step S101 of FIG. 3. Therefore, it is not necessary to update the register values at the lower levels. Therefore, the encoded data can be decoded faster than in the conventional image decoding apparatus.

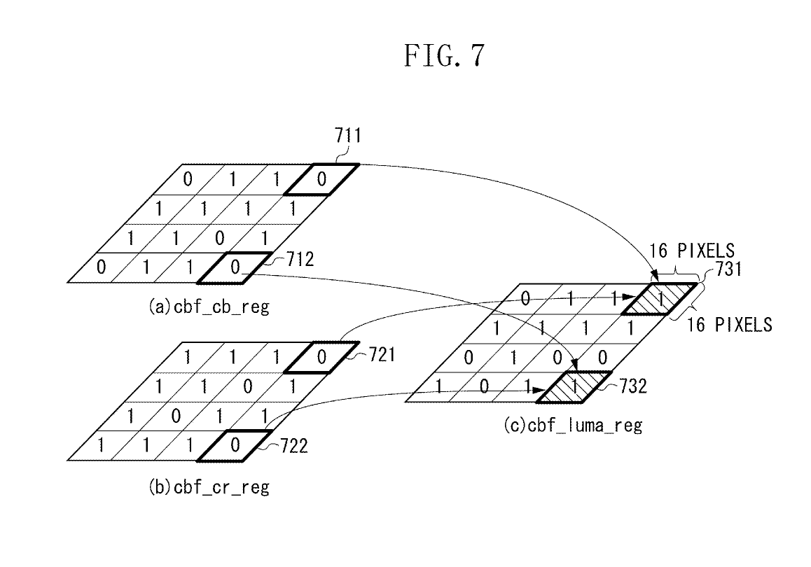

Next, how the value of the luminance CBF register is updated will be described with reference to FIG. 7. For the sake of simplicity, it is assumed that all CUs (coding units) forming a CTU have a size of 16×16 pixels, a prediction mode is inter prediction, and CBFs illustrated as an example in FIG. 7 all correspond to a level #0 of a transform tree.

Parts (a) and (b) of FIG. 7 illustrate a register cbf_cb_reg[ ] [ ] [ ] and a register cbf_cr_reg[ ][ ][ ], respectively, which correspond to a color-difference CBF. Part (c) of FIG. 7 illustrates the value of a register cbf_luma reg[ ][ ][ ] corresponding to a luminance CBF. The value of a CBF in each of regions 711 to 722 in FIG. 7 is “0”. Further, the prediction mode is the inter prediction. The size of the CU is 16×16 pixels and thus, the level number of the CBF is “0”. Therefore, a luminance CBF corresponding to each of regions 731 and 732 in Part (c) of FIG. 7 does not appear in encoded data, and “1” is implicitly derived as a luminance CBF value. The values of the registers holding the values of the luminance CBFs are all initialized to “1” in step S101 of FIG. 3 and thus, it is not necessary to update the register holding the value of the luminance CBF. Therefore, fast decoding processing can be performed.

The sizes of CTU, CU, and TU according to the exemplary embodiment of the present invention are not limited to those described above, and any value can be used for these sizes. Further, a color-difference subsampling format is not limited to 4:2:0, and any format such as 4:2:2 and 4:4:4 can be used.

In the above-described exemplary embodiment, each processing unit illustrated in FIGS. 1 and 2 is configured with hardware. However, the processing to be performed in each processing unit illustrated in FIGS. 1 and 2 may be configured using a computer program.

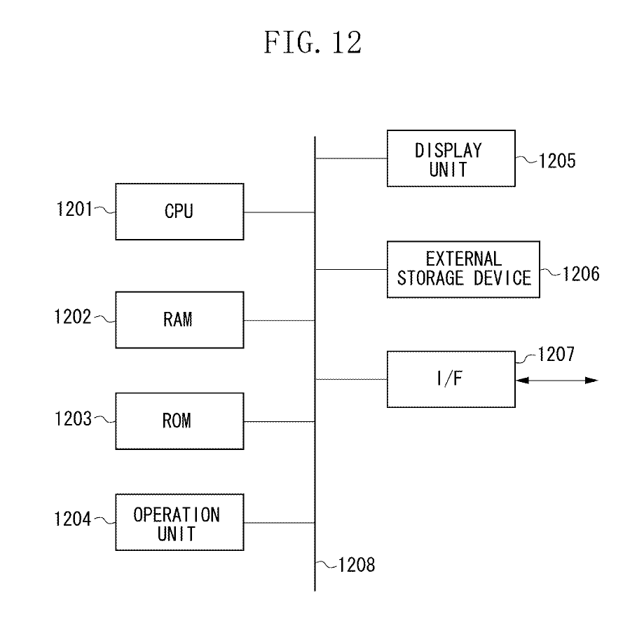

FIG. 12 is a block diagram illustrating a hardware configuration example of a computer applicable to the image decoding apparatus according to the above-described exemplary embodiment.

A central processing unit (CPU) 1201 controls the entire computer, by using a computer program and data stored in a random access memory (RAM) 1202 and a read only memory (ROM) 1203. The CPU 1201 also executes each process described above as a process performed by the image processing apparatus according to the exemplary embodiment. In other words, the CPU 1201 serves as each of the processing units illustrated in FIGS. 1 and 2.

The RAM 1202 has an area for temporarily storing a computer program as well as data loaded from an external storage device 1206, and data acquired from outside via an interface (I/F) 1207. Further, the RAM 1202 has a working area to be used by the CPU 1201 in executing various processing. In other words, for example, the RAM 1202 can provide an area for a frame memory or other various areas as appropriate.

The ROM 1203 stores setting data of the computer, a boot program, and the like. An operation unit 1204 includes components such as a keyboard and a mouse. The operation unit 1204 can input various instructions to the CPU 1201 according to operation performed by a user of the computer. A display unit 1205 displays results of processing performed by the CPU 1201. The display unit 1205 is configured of, for example, a liquid crystal display.

The external storage device 1206 is a large-capacity information storage device represented by a hard disk drive device. The external storage device 1206 stores an operating system (OS) and a computer program for causing the CPU 1201 to implement the function of each unit illustrated in FIGS. 1 and 2. Further, the external storage device 1206 may store each piece of image data as a processing target.

The computer program and the data stored in the external storage device 1206 are loaded as appropriate to the RAM 1202 according to control by the CPU 1201, to be processed by the CPU 1201. Networks such as a local area network (LAN) and the Internet, and other devices such as a projection device and a display device can be connected to the I/F 1207. The computer can acquire and transmit various kinds of information via the I/F 1207. A bus 1208 is provided to interconnect the above-described units.

The CPU 1201 controls the operation described above with reference to the flowchart, by the units thus configured.

In other words, the above-described operation is achieved also by supplying a storage medium that records code of a computer program for implementing the above-described function, to a system, and causing the system to read and execute the code of the computer program. In this case, the code of the computer program read from the storage medium implements the above-described function of the exemplary embodiment, and the storage medium storing the code of the computer program is an exemplary embodiment of the present invention. In addition, the operating system (OS) and the like running on the computer may perform some or all of actual processing based on an instruction in the program code, and this processing may implement the above-described function. Exemplary embodiments of the present invention also include such a case.

Further, the above-described function may be implemented as follows. First, code of a computer program is read from a storage medium and then written in a memory of a function expansion card inserted into a computer or a function expansion unit connected to the computer. Subsequently, based on an instruction in the code of the computer program, a CPU or the like of the function expansion card or the function expansion unit performs some or all of actual processing, to implement the above-described function. Exemplary embodiments of the present invention also include such a case.

When the above-described exemplary embodiment is applied to the above-described storage medium, the storage medium stores the code of the computer program corresponding to the above-described flowchart.

In an image decoding apparatus according to an exemplary embodiment of the present invention, values held by a coded-block-flag holding unit are all initialized to a predetermined initial value before the start of processing for each coding tree unit in a picture. When the value of a coded block flag decoded by a syntax-element decoding unit is different from the initial value, the corresponding value held by the coded-block-flag holding unit is updated to the value of the coded block flag. Therefore, according to a result of decoding of the coded block flag decoded as a syntax element, the value of a coded block flag at a level below the coded block flag is implicitly derived and thus, it is not necessary to update the value held by the coded-block-flag holding unit. Accordingly, decoding processing can be performed faster than before.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-032212 filed Feb. 21, 2014, which is hereby incorporated by reference herein in its entirety.

What is claimed is:

1. An image decoding apparatus that decodes encoded data representing an encoded picture that is split using a coding tree unit including coding units hierarchically defined in a tree structure, as a unit, wherein the coding unit includes a transform tree including transform units hierarchically defined in a tree structure, and the encoded data includes a coded block flag indicating whether each of the transform units includes a non-zero value, the image decoding apparatus comprising:
a decoding unit configured to decode the coded block flag;
a holding unit configured to hold a value of the coded block flag corresponding to each of the transform units; and
a flag-value updating unit configured to update the value of the coded block flag held by the holding unit, which
initializes the value of the coded block flag held by the holding unit to a predetermined initial value (indicating zero at a lower level) before processing is performed on the coding tree unit;
updates, in a case where a value of the coded block flag for a target transform unit, decoded by the decoding unit is different from the predetermined initial value,
among the coded block flags held by the holding unit, the value of the coded block flag for the target transform unit, and
the value of the coded block flag for a transform unit at a level below the transform unit,
to the value of the coded block flag decoded by the decoding unit; and
uses, in a case where the value of the coded block flag for the target transform unit, decoded by the decoding unit is equal to the predetermined initial value,
among the coded block flags held by the holding unit, the value of the coded block flag for the target transform unit, and
the value of the coded block flag for a transform unit in a layer below the transform unit,
as the value of the coded block flag encoded by the decoding unit.

2. The image decoding apparatus according to claim 1, wherein the coded block flag represents whether, of a luminance and a color-difference component forming a pixel, a transform unit corresponding to the color-difference component includes a non-zero value, and the predetermined initial value is 0 indicating that the non-zero value is not included.

3. The image decoding apparatus according to claim 1, wherein the coded block flag represents whether, of the luminance and the color-difference component forming a pixel, a transform unit corresponding to the luminance component includes a non-zero value, and the predetermined initial value is 1 indicating that the non-zero value is not included.

4. An image decoding method for decoding encoded data representing an encoded picture that is split using a coding tree unit including coding units hierarchically defined in a tree structure, as a unit, wherein the coding unit includes a transform tree including transform units hierarchically defined in a tree structure, and the encoded data includes as a syntax element a coded block flag indicating whether each of the transform units includes a non-zero value, the image decoding method comprising steps of:
decoding the coded block flag;
holding a value of the coded block flag corresponding to each of the transform units, in a holding unit; and
updating the value of the coded block flag held by the holding unit, the updating includes
initializing the value of the coded block flag held by the holding unit to a predetermined initial value (indicating zero at a lower level), before processing is performed on the coding tree unit;
updating, in a case where a value of the decoded coded block flag for a target transform unit is different from the predetermined initial value,
among the coded block flags held by the holding unit, the value of the coded block flag for the target transform unit, and
the value of the coded block flag for a transform unit at a level below the transform unit,
to the value of the decoded coded block flag; and
using, in a case where the value of the decoded coded block flag for the target transform unit is equal to the predetermined initial value,
among the coded block flags held by the holding unit, the value of the coded block flag for the target transform unit, and
the value of the coded block flag for a transform unit in a layer below the transform unit,
as the value of the decoded coded block flag.

5. A non-transitory storage medium storing a program that causes a computer to serve as the image decoding apparatus according to claim 4, when the program is read and executed by the computer.
